(19) United States
(12) Patent Application Publication
(10) Pub. No.: US 2021/0324907 A1
(43) Pub. Date: Oct. 21, 2021

(54) KINEMATIC IDLER ROLLER

(71) Applicant: 3M INNOVATIVE PROPERTIES COMPANY, St. Paul, MN (US)

(72) Inventors: Karl K. Stensvad, Inver Grove Heights, MN (US); Scott L. Ciliske, St. Paul, MN (US); Ronald P. Swanson, Woodbury, MN (US)

(21) Appl. No.: 17/247,499

(22) PCT Filed: Jun. 21, 2019
(86) PCT No.: PCT/IB2019/055265

§ 371 Date: Dec. 14, 2020

Related U.S. Application Data
(60) Provisional application No. 62/690,448, filed on Jun. 27, 2018.

(51) Int. Cl. F16C 13/06; F16C 23/04; B65G 39/09

(52) U.S. Cl. CPC F16C 13/06; F16C 2326/58; B65G 39/09; F16C 23/043

(57) ABSTRACT

An idler roller having a fixed shaft with at least one spherical bearing and a second bearing which may, but need not be, a spherical bearing. In some embodiments, the second bearing is slidably-mounted on a central shaft. A shell is mounted between these bearings. Any changes in dimensions resulting from changes in temperature may them be accommodated by sliding movement of the second bearing, sparing the shell from distortion by bending or buckling. In other exemplary embodiments, the spherical bearing includes a first housing element fixedly-mounted on a central shaft and a complementary first free element disposed against the first housing element. A second bearing element is mounted on the central shaft, and a shell is attached to the first free element and rotatably-mounted to a second bearing element with a biasing element mounted on the central shaft urging a second free element away from the first free element.

### BACKGROUND

In recent years the fabrication of products in the form of, or conversion from, an indefinite length web of material has become a popular method of manufacture whenever the product lends itself to such methods. High production rates and lower costs are often obtained when web-based roll-to-roll manufacturing processes are used. A well-developed art has grown up around the need for moving and handling webs of indefinite length when such web-based methods are used.

Fixed-shaft idler rollers are commonly used to support and/or deflect indefinite length webs during production processes. It is usually desirable to construct such idler rollers to present minimal rotational friction to the web being supported. Energy losses caused by rotational friction in the idler roller is made up by the transfer of kinetic energy from the web to the idler roller. This is undesirable for several reasons, including the possibility of loss of precision tension control over the web.

Fixed-shaft idler rollers are generally preferred over similar live-shaft rollers for various reasons. Fixed-shaft rollers may have less roller face deflection than a similar live-shaft design because the bearings are located in headers (i.e., closer to the center of the roller). Additionally, it is generally easier to mount and maintain the alignment of fixed-shaft rollers on manufacturing equipment than live-shaft rollers.

### SUMMARY

High precision applications within roller-to-roller processing require that web and rollers are positioned to better than 5 microns. Some of these high precision applications include registered microreplication, registered printing, and roller-metered coating. Web guides providing such positional control need idlers with error motion (both axial and radial) of less than the steering specification. A particular difficulty arises when such precision rollers are required to maintain their precise positional tolerances over a range of temperatures. Changes in temperature generally result in a change in the dimensions of the parts within the roller, thereby affecting their precise positioning, alignment and performance.

In general, the present disclosure is directed to an idler roller having a fixed shaft with at least one spherical (e.g., hemi-spherical) bearing and a second bearing which may, but need not be, a spherical (e.g., hemi-spherical) bearing.

The second bearing is slidably-mounted on the shaft. A shell is mounted between these bearings. Any changes in dimensions resulting from changes in temperature may them be accommodated by sliding movement of the second bearing, sparing the shell from distortion by bending or buckling.

In one aspect, the present disclosure is directed to a roller having a fixed central shaft; a first spherical bearing comprising a first housing element fixedly-mounted on the central shaft and a complementary first free element disposed against the first housing element; a second bearing comprising a second housing element slidably-mounted on the central shaft and a complementary second free element disposed against the second housing element; and a shell attached to both the first and the second free elements.

In some embodiments, the second bearing comprises a spherical bearing. In alternative embodiments, the second bearing comprises a radial bearing. In such an embodiment, a planar thrust bearing advantageously may be present to aid in preloading the radial bearing, as the radial bearing is an over-constrained system for which deformation to the idler shaft or shell would exert a moment likely impacting the precision of the assembly.

In certain exemplary embodiments, there will be a means for urging the second housing element against the second free element, such as a pressurized piston; spring-loaded collar; hydraulic, pneumatic, or electric actuator; or a compliant mechanical device (e.g., a spring or flexible shim).

In other exemplary embodiments, an air bushing is attached to the second housing element for constraining motion of the second housing element to rotation about and translation along the axis of the fixed central shaft.

In another aspect, the present disclosure is directed to a roller having a fixed central shaft; a first spherical bearing comprising a first housing element fixedly-mounted on the central shaft and a complementary first free element disposed against the first housing element; a second free element rotatably-mounted on the central shaft; a shell attached to both the first and the second free elements; and a biasing element mounted on the central shaft urging the second free element away from the first free element.

In some exemplary embodiments, the roller further includes a radial bushing supporting the shell and allowing for free rotational movement of the shell while accommodating thermal extension of the shell. In certain embodiments, the biasing element is selected from the group consisting of a pressurized piston; a spring-loaded collar; a hydraulic, pneumatic, or electric actuator; a spring; and a flexible shim.

In a further aspect, the present disclosure is directed to a roller having a fixed central shaft; a first spherical bearing comprising a first housing element fixedly-mounted on the central shaft and a complementary first free element disposed against the first housing element; a second bearing mounted on the central shaft; a shell attached to the first free element and rotatably-mounted to the second bearing; and a biasing element mounted on the central shaft urging the second bearing away from the first free element.

In some exemplary embodiments, the roller further includes a radial bushing supporting the shell and allowing for free rotational movement of the shell while accommodating thermal extension of the shell. In certain embodiments the second bearing is a spherical bearing. In other embodiments, the second bearing is a radial bearing. In further embodiments, the biasing element is selected from the group consisting of a pressurized piston; a spring-loaded collar; a hydraulic, pneumatic, or electric actuator; a spring; and a flexible shim.

### LISTING OF EXEMPLARY EMBODIMENTS

Embodiment A. A roller, comprising:
a fixed central shaft;
a first bearing mounted on the central shaft, the first bearing being a spherical bearing comprising a first housing element fixedly-mounted on the central shaft and a complementary first free element disposed against the first housing element;
a second bearing comprising a second housing element mounted on the central shaft and a complementary second free element disposed against the second housing element; and
a shell attached to both the first and the second free elements.

Embodiment B. A roller according to Embodiment A, wherein the second bearing is a spherical bearing.

Embodiment C. A roller according to Embodiment A, wherein the second bearing is a radial bearing.

Embodiment D. A roller according to any one of Embodiments A through C, further comprising a means for urging the second housing element against the second free element.

Embodiment E. A roller according to any one of Embodiments A through D, wherein the means for urging the second housing element against the second free element is selected from the group consisting of a pressurized piston; a spring-loaded collar; a hydraulic, pneumatic, or electric actuator; a spring; and a flexible shim.

Embodiment F. A roller according to any one of Embodiments A through E, wherein the second housing element is slidably-mounted on the central shaft

Embodiment G. A roller according to any one of Embodiments A through F, further comprising an air bushing attached to the second housing element, wherein the air bushing constrains motion of the second housing element to rotation about and translation along the axis of the fixed central shaft.

Embodiment H. A roller, comprising:
a fixed central shaft;
a first bearing mounted on the central shaft, the first bearing being a spherical bearing comprising a first housing element fixedly-mounted on the central shaft and a complementary first free element disposed against the first housing element;
a second free element rotatably-mounted on the central shaft;
a shell attached to both the first and the second free elements; and
a biasing element mounted on the central shaft urging the second free element away from the first free element.

Embodiment I. The roller according to Embodiment H, further comprising a radial bushing supporting the shell and allowing for free rotational movement of the shell while accommodating thermal extension of the shell.

Embodiment J. A roller according to Embodiment H or I, wherein the biasing element is selected from the group consisting of a pressurized piston; a spring-loaded collar; a hydraulic, pneumatic, or electric actuator; a spring; and a flexible shim.

Embodiment K. A roller, comprising:
a fixed central shaft;
a first bearing mounted on the central shaft, the first bearing being a spherical bearing comprising a first housing element fixedly-mounted on the central shaft and a complementary first free element disposed against the first housing element;
a second bearing mounted on the central shaft;
a shell attached to the first free element and rotatably-mounted to the second bearing; and
a biasing element mounted on the central shaft urging the second bearing away from the first free element.

Embodiment L. The roller of Embodiment K, further comprising a radial bushing supporting the shell and allowing for free rotational movement of the shell while accommodating thermal extension of the shell.

Embodiment M. A roller according to Embodiment K or L, wherein the second bearing is a spherical bearing.

Embodiment N. A roller according to any one of Embodiments K, L or M, wherein the second bearing is a radial bearing.

Embodiment O. A roller according to any one of Embodiments K, L, M, or N, wherein the biasing element is selected from the group consisting of a pressurized piston; a spring-loaded collar; a hydraulic, pneumatic, or electric actuator; a spring; and a flexible shim.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF DRAWINGS

The disclosure may be more completely understood in consideration of the following detailed description of various embodiments of the disclosure in connection with the accompanying figures, in which:

FIG. 1 is cross-section side view of an embodiment of an idler roller according to the present disclosure.

FIG. 2 is a perspective view of the idler of FIG. 1 with the shell removed and the cylinder rendered transparent for clarity.

FIG. 3 is a cross-section side schematic view of an alternate embodiment of the idler roller according to the present disclosure.

While the above-identified drawings, which may not be drawn to scale, set forth various embodiments of the present disclosure, other embodiments are also contemplated, as noted in the Detailed Description.

### DETAILED DESCRIPTION

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

The present disclosure is directed to a roller having a fixed central shaft; a first spherical bearing comprising a first housing element fixedly-mounted on the central shaft and a complementary first free element disposed against the first housing element; a second bearing comprising a second housing element slidably-mounted on the central shaft and a complementary second free element disposed against the second housing element; and a shell attached to both the first and the second free elements. A bearing generically is a device meant to eliminate some degrees-of-freedom while maintaining others, while carrying a load. The first or second bearings may be any of, but not limited to, aerostatic bearings, hydrostatic bearings, hydrodynamic bearings, roller elements, and ordinary ball bearings.

In some embodiments, the second bearing comprises a spherical (e.g., hemi-spherical) bearing. In alternative embodiments, the second bearing comprises a radial bearing. In such an embodiment, a planar thrust bearing advantageously may be present to aid in preloading the radial bearing, as the radial bearing is an over-constrained system for which deformation to the idler shaft or shell would exert a moment likely impacting the precision of the assembly.

In certain exemplary embodiments, there will be a means for urging the second housing element against the second free element, such as a pressurized piston; spring-loaded collar; hydraulic, pneumatic, or electric actuator; or a compliant mechanical device (e.g., a spring or flexible shim). Hydraulic or pneumatic actuators are typically piston-type cylinders, but alternatively or additionally could be rotary motors attached to a lead screw, or the like. An electric actuator is typically a motor (e.g., a linear or rotary electric motor), voice coil, piezoelectric actuator, and the like. A compliant mechanical device is most simply a spring, but other configurations may be used (e.g., a flexible solid shim wherein mechanical energy is stored in the flexure of the shim).

It should be understood that references such as ‘towards’ or ‘away from’ are dependent on the bearing orientation, and therefore could be reversed and remain within the scope of the presently disclosed embodiments.

In certain exemplary embodiments, an air bushing is attached to the second housing element for constraining motion of the second housing element to rotation about and translation along the axis of the fixed central shaft.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

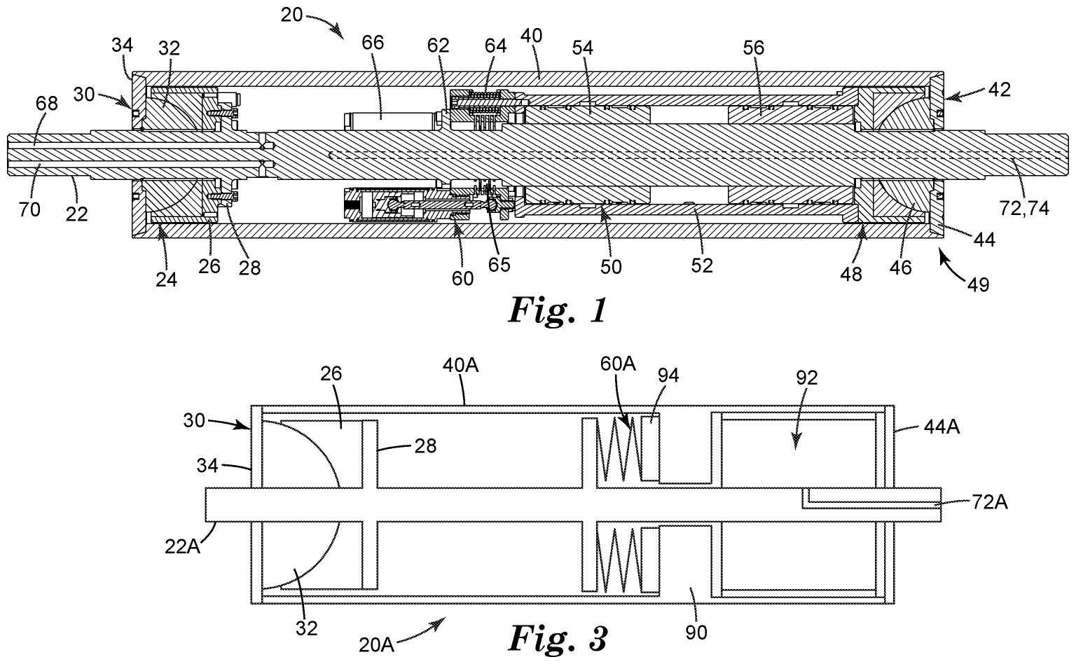

Referring now to FIG. 1, a cross-section side view of an embodiment of an idler roller 20 according to the present disclosure is illustrated. Idler roller 20 includes a fixed shaft 22. While the illustrated embodiments show fixed shaft 22 as a single element, it is considered within the scope of the disclosure that fixed shaft 22 be embodied as two cantilevered shafts on approximately the same axis. A first spherical (i.e., hemi-spherical as shown in FIG. 1) bearing 24 is present, including a first housing element 26 fixedly-mounted via flange 28 on fixed shaft 22, and a complementary first free element 30 disposed against first housing element 26. Those of ordinary skill in the art will understand that “disposed against” allows for a layer of fluid material, for example lubricating liquid or supplied gas, serving to facilitate movement of one element relative to the other. The first free element 30 includes a first spherical portion 32 and a first shell mount 34. First shell mount 34 is connected to a shell 40, which is in turn connected to a second free element 42 at its other end. More specifically shell 40 is connected to a second shell mount 44, which is in turn connected to second spherical portion 46. Second shell mount 44 and second spherical portion 46 together comprise second free element 42. Second spherical portion 46 is disposed against a complementary second fixed element 48. (By “fixed” it is meant that the element is fixed rotationally. It may translate axially.) Second spherical portion 46 and second fixed element 48 together define second bearing 49.

It is desirable that second fixed element 48 be urged against second free element 42. This is accomplished by biasing element 50, which includes a cylinder 52 attached to second fixed element 48. In the depicted embodiment, first and second air bushings, 54 and 56 respectively, are present to allow free axial movement of cylinder 52.

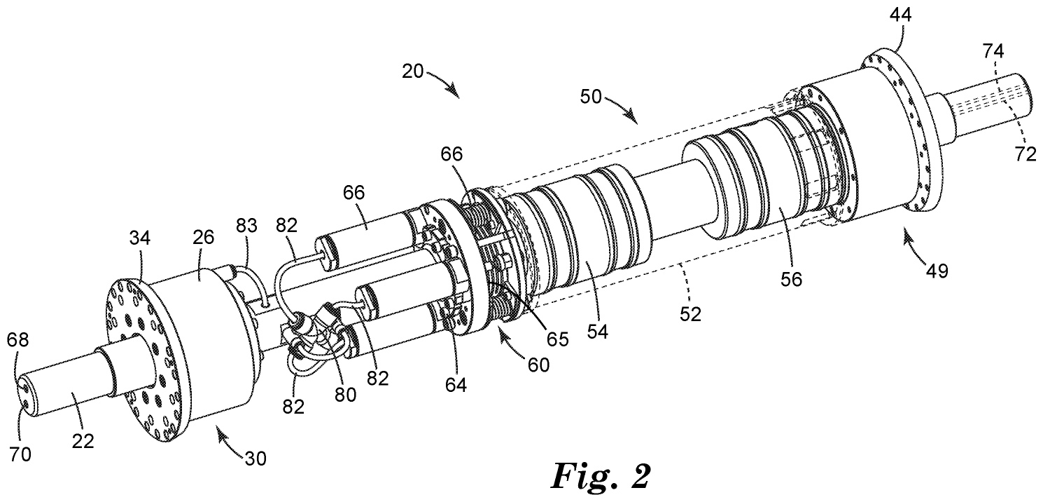

A force element 60 is present to apply a biasing force to cylinder 52. Force element 60 is mounted on fixed shaft 22 via flange 62. Force element 60 may include one or more springs 64. A flexure element 65 may be present to constrain the rotation of biasing element 50. In the depicted embodiment, air cylinders 66 are present to provide an adjustable biasing force on cylinder 52. Air cylinders 66 receive compressed air from air channel 68 so as to provide and change this biasing force. The manifold 80 and the tubes 82 that carry air from air channel 68 to air cylinders 66 have been omitted from FIG. 1 for visual clarity, but can be seen in FIG. 2. Tube 83 that carries air from air channel 70 to first spherical bearing 24 has been omitted from FIG. 1 for visual clarity, but can be seen in FIG. 2. The tubing that carries air from air channel 72 to air bushings 54 and 56 has also been omitted for visual clarity from all figures.

Air channel 72 provides air for air bushings 54 and 56, while air channel 74 provides air for second bearing 49 (Air channel 74 is behind 72 in this view). The tubing from air channels 72 and 74 have been omitted for clarity.

Referring now to FIG. 2, a perspective view of the idler of FIG. 1 with the shell 40 removed, and the cylinder 52 rendered transparent for clarity, is illustrated. In this view, the manifold 80 and tubes 82 which bring pressurized air to air cylinders 66 from channel 68 has been illustrated. Tube 83 carries pressurized air from air channel 70 to operate first spherical bearing 24.

Referring now to FIG. 3, a cross-section side schematic view of an alternate embodiment of an idler roller 20A according to an embodiment of the present disclosure is illustrated. Idler roller 20A includes a fixed shaft 22A. A first spherical bearing 24 is present, including a first housing element 26 fixedly-mounted via flange 28 on fixed shaft 22, and a complementary first free element 30 disposed against first housing element 26. The first free element 30 includes a first spherical portion 32 and a first shell mount 34. First shell mount 34 is connected to a shell 40A, which is in turn connected to a second shell mount 44A at its other end.

A force (i.e., biasing) element 60A exerts axial thrust between flange 62A on shaft 22A, and flange 90 on shell 40A through thrust bearing element 94, so as to urge first shell mount 34 away from flange 90. In the depicted embodiment, force element 60A is a spring, however other expedients such as described above in connection with the previous embodiment can also serve. One skilled in the art could envision alternate configurations of thrust preload and radial bushings and bearings to allow the equivalent rotational and axial free motions.

A radial bearing 92 is present to allow free axial and rotational movement of shell 40A. Air bearing 92 receives air for its operation via air channel 72A.

Additional embodiments of the present disclosure are directed to a roller having a fixed central shaft; a first spherical bearing comprising a first housing element fixedly-mounted on the central shaft and a complementary first free element disposed against the first housing element; a second free element rotatably-mounted on the central shaft; a shell attached to both the first and the second free elements; and a biasing element mounted on the central shaft urging the second free element away from the first free element.

In some such exemplary embodiments, the roller further includes a radial bushing supporting the shell and allowing for free rotational movement of the shell while accommodating thermal extension of the shell. In certain such embodiments, the biasing element is selected from the group consisting of a pressurized piston; a spring-loaded collar; a hydraulic, pneumatic, or electric actuator; a spring; and a flexible shim.

Further embodiments of the present disclosure are directed to a roller having a fixed central shaft; a first spherical bearing comprising a first housing element fixedly-mounted on the central shaft and a complementary first free element disposed against the first housing element; a second bearing mounted on the central shaft; a shell attached to the first free element and rotatably-mounted to the second bearing; and a biasing element mounted on the central shaft urging the second bearing away from the first free element.

In some such exemplary embodiments, the roller further includes a radial bushing supporting the shell and allowing for free rotational movement of the shell while accommodating thermal extension of the shell. In certain such embodiments the second bearing is a spherical bearing. In alternate embodiments, the second bearing is a radial bearing. In further embodiments, the biasing element is selected from the group consisting of a pressurized piston; a spring-loaded collar; a hydraulic, pneumatic, or electric actuator; a spring; and a flexible shim.

The operation of certain embodiments of the present disclosure will be further described with regard to the following detailed example. This example is offered to further illustrate the various specific and preferred embodiments and techniques. It should be understood, however, that many variations and modifications may be made while remaining within the scope of the present disclosure.

### EXAMPLE

Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Example 1

An idler roller generally as depicted in FIGS. 1 and 2 was prepared. The roller had a fixed shaft at its mounting location of diameter 1 inch (25.4 mm) and a shell with an outside diameter of 4 inches (102 mm) and a length at room temperature of 20 inches 48.8 cm. These dimensions provide the idler with an ability to handle a radial load of 50 pounds (222 N). The first and second spherical bearings were porous graphite spherical air bearings custom designed from New Way Air Bearings of Aston, Pa. The first spherical air bearing fixes the shell in three translational degrees of freedom of with respect to the fixed shaft. The cylinder was in contact with two air bushings, commercially available as S303801 from New Way Air Bearings, which constrain the fixed element of the second air spherical air bearing in all degrees of freedom except translation and rotation about the primary axis of the fixed shaft. During operation, biasing element 50 imposed a net load on the second spherical air bearing away from the first spherical air bearing. As a result, the only shell degree of freedom that is not constrained is the rotation about the axis of the fixed shaft.

More specifically, in use the air bearings and air bushings were provided with compressed air pressure through the several air channels at a level of 60 psi (0.41 MPa) to operate the air bearings and air bushings properly. The pressurized cavity was vented through the end plates to ambient.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A roller, comprising:
a fixed central shaft;
a first spherical bearing comprising a first housing element fixedly-mounted on the central shaft and a complementary first free element disposed against the first housing element;
a second bearing comprising a second housing element mounted on the central shaft and a complementary second free element disposed against the second housing element; and
a shell attached to both the first and the second free elements.

2. The roller according to claim 1, wherein the second bearing is a spherical bearing.

3. The roller according to claim 1, wherein the second bearing is a radial bearing.

4. The roller according to claim 1, further comprising a means for urging the second housing element against the second free element.

5. The roller according to claim 4, wherein the means for urging the second housing element against the second free element is selected from the group consisting of a pressurized piston; a spring-loaded collar; a hydraulic, pneumatic, or electric actuator; a spring; and a flexible shim.

6. A roller according to claim 1, wherein the second housing element is slidably-mounted on the central shaft.

7. A roller according to claim 1, further comprising an air bushing attached to the second housing element, wherein the air bushing constrains motion of the second housing element to rotation about and translation along the axis of the fixed central shaft.

8. A roller, comprising:
a fixed central shaft;
a first spherical bearing comprising a first housing element fixedly-mounted on the central shaft and a complementary first free element disposed against the first housing element;
a second free element rotatably-mounted on the central shaft;
a shell attached to both the first and the second free elements; and
a biasing element mounted on the central shaft urging the second free element away from the first free element.

9. The roller according to claim 8, further comprising a radial bushing supporting the shell and allowing for free rotational movement of the shell while accommodating thermal extension of the shell.

10. A roller according to claim 8, wherein the biasing element is selected from the group consisting of a pressurized piston; a spring-loaded collar; a hydraulic, pneumatic, or electric actuator; a spring; and a flexible shim.

11. A roller, comprising:
a fixed central shaft;
a first spherical bearing comprising a first housing element fixedly-mounted on the central shaft and a complementary first free element disposed against the first housing element;
a second bearing mounted on the central shaft;
a shell attached to the first free element and rotatably-mounted to the second bearing; and
a biasing element mounted on the central shaft urging the second bearing away from the first free element.

12. The roller according to claim 11, further comprising a radial bushing supporting the shell and allowing for free rotational movement of the shell while accommodating thermal extension of the shell.

13. A roller according to claim 11, wherein the second bearing is a spherical bearing.

14. A roller according to claim 13, wherein the second bearing is a radial bearing.

15. A roller according to claim 11, wherein the biasing element is selected from the group consisting of a pressurized piston; a spring-loaded collar; a hydraulic, pneumatic, or electric actuator; a spring; and a flexible shim.
